(19) United States
(12) Patent Application Publication
(10) Pub. No.: US 2006/0026875 A1
(43) Pub. Date: Feb. 9, 2006

(54) Apparatus for generating shadow display images and design methodology therefor

(76) Inventor: Joost Elffers, New York, NY (US)

Correspondence Address: Scully, Scott, Murphy & Presser, 400 Garden City Plaza, Garden City, NY, 11530, US

(21) Appl. No.: 10/914,104

(22) Filed: Aug. 9, 2004

(51) Int. Cl. G09F 13/00

(52) U.S. Cl. 40/560

(57) ABSTRACT

A novel shadow display apparatus includes a three-dimensional object that is implemented for projecting shadows on a surface when a light source is directed, and which is of an abstract shape such that an observer viewing the object at locations other than at the light source would not be able to identify what the projected shadow would be from the object/structure. A methodology for designing such a shadow display object or structure having an abstract three-dimensional shape, such as the shape of a tree or bush having branch members, and from which an observer viewing the object at locations other than at the light source would not be able to identify what the projected shadow would be from the tree-shaped object or structure. The apparatus may be used for displaying shadow images of symbols, both religious and secular, and may be of any scale.

### BACKGROUND OF THE INVENTION

1. Field of the Invention

This invention relates generally to shadow display devices, and, particularly, to a novel apparatus and method for generating a unique shadow display object having an abstract shape.

2. Description of the Prior Art

Shadow display objects produce a shadow against a surface when light from a light source is directed to the object. Shadows projected against the surface typically take the form of the display objects itself. That is, a casual observer could easily discern what the projected shadow would be from the object itself.

A currently available shadow display device described in U.S. Pat. No. 6,502,339 which teaches a shadow display device including semi-transparent panels having images thereon which are positioned in front of or behind a light source casting images on a surface. While the shape of the “object” itself is different than the image displayed, it is obvious that an observer would easily be able to identify what the resultant projected shadow would be from the image on the semi-transparent panel. Thus, the “object” itself is transparent and of a flat shape with an essentially two-dimensional image or image outline thereon. While U.S. Pat. No. 6,502,339 teaches the use of two semi-transparent panels between the projected shadow surface and a light source, thus, essentially providing a “three dimensional” object having images thereon that can be used to generate a single displayed shadow, an observer would readily be able to determine the resultant shadow from viewing the images on the individual transparent panels making up the “object”.

A teaching in the book “Art and Illusion: A Study in the Psychology of Pictorial Representation”, Bollengen Series xxxv.5, 1960, pages 242-250, describes how the use of perspective can create an illusion as exemplified by a “peep” show whereby a user may visualize an “object” by looking through a hole, yet, when viewing the object from another angle, visualizes an illusion comprising, for example, either a distorted view of the object or something completely non-coherent. However, this reference does not teach use of the illusion in the context of a shadow display whereby a shadow becomes the illusion generated by a 3-dimensional object.

It would be highly desirable to provide a shadow display apparatus for producing shadow displays, wherein the display apparatus includes a light source, and an object or structure having an abstract form, such as the shape of a tree or bush having branch members, and from which an observer viewing the object at locations other than at the light source would not be able to identify what the projected shadow would be from the object/structure.

It would further be highly desirable to provide a novel shadow display object or structure having an abstract form, such as the shape of a tree or bush having branches, that is implemented for casting shadows when a light source is applied, and from which an observer viewing the object at locations other than at the light source would not be able to identify what the projected shadow would be from the object/structure

It would also be highly desirable to provide a methodology for designing such a shadow display object or structure having an abstract form, such as the shape of a tree or bush having branch members, from which an observer viewing the object at locations other than at the light source would not be able to discern what the projected shadow would be from the object/structure

### SUMMARY OF THE INVENTION

It is thus an object of the present invention to provide a novel shadow display apparatus for producing shadow displays, wherein the display apparatus includes a light source, and an object or structure having an abstract form, such as the shape of a tree or bush having branch members, whereby an observer viewing the object at locations other than at the light source would not be able to identify what the projected shadow would be from the object/structure.

It is a further object of the present invention to provide a novel shadow display object having an abstract shape that is implemented for casting shadows on a surface when a light source is applied, and which is of an abstract shape such that an observer viewing the object at locations other than at the light source would not be able to identify what the projected shadow would be from the object/structure.

It is a further object of the present invention to provide a methodology for designing such a shadow display object or structure having an abstract three-dimensional shape, such as the shape of a tree or bush having branch members, and from which an observer viewing the object at locations other than at the light source would not be able to identify what the projected shadow would be from the tree-shaped object or structure.

It is another object of the present invention to provide a computer program product from which a shadow display object or structure having an abstract shape may be designed, such an object having an abstract three-dimensional shape, such as the shape of a tree or bush having branch members, whereby an observer viewing the object at locations other than at the light source would not be able to identify what the projected shadow would be from the object/structure.

Advantageously, the shadow display device is capable of generating shadow images of both religious and secular symbols, objects, company logos, etc. on both large and small scales.

### BRIEF DESCRIPTION OF THE DRAWINGS

Further features, aspects and advantages of the structures and methods of the present invention will become better understood with regard to the following description, appended claims, and accompanying drawings where:

FIGS. 1(a)-1(p) depicts a Tree of Life building process for casting shadow displays of symbols (e.g., Star of David) according to the present invention;

FIGS. 2(a) and 2(b) illustrate the intersection of defined planes respectively with a traverse lying plane and FIG. 2(c) depicts all defined planes of the resultant shadow (Star of David) and the intersection between all planes;

FIG. 3(b) illustrates an example of the join in between the branches of the two defined planes and, FIG. 3(a) depicts a location or intersecting point of both planes;

FIG. 3(c) illustrates the shadow projected by the branches defined at these planes and the arrow indicates their intersection on the shadow; and,

FIG. 4 depicts a defined location of a light source in any direction from the shape that will be projected;

FIG. 5(a)-5(d) depicts the design of the virtual model of a designed tree/bush with branch members structure relative to the light source when viewed by an observer at different angles;

FIGS. 6(a)-6(c) depict an exemplary candle holder structure for supporting a light source and a designed tree/bush with branch members structure created from the virtual 3D model using the CAD design process exemplified by the present invention;

FIG. 7 depicts an exemplary candle holder structure for supporting a light source and a designed tree/bush with branch members structure created from the virtual 3D model that is wall mounted;

FIG. 8 depicts an exemplary candle holder structure for supporting a light source and a designed tree/bush with branch members structure created from the virtual 3D model that is suspended from a ceiling; and,

FIG. 9 depicts a shadow display apparatus comprising three (3) tree/bush structures in alignment have been designed to project a single Star of David shadow image in accordance with the invention.

### DETAILED DESCRIPTION OF THE PREFERRED EMBODIMENTS

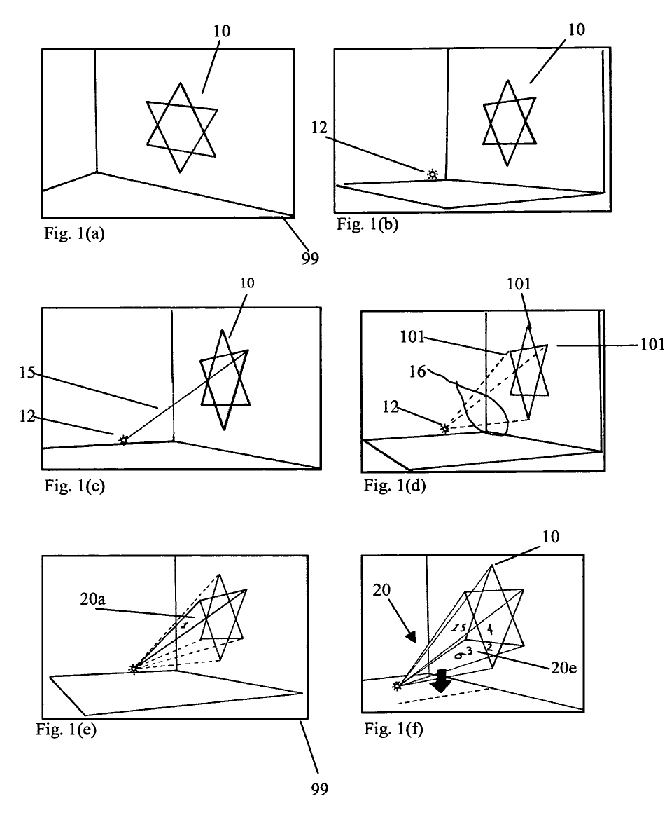

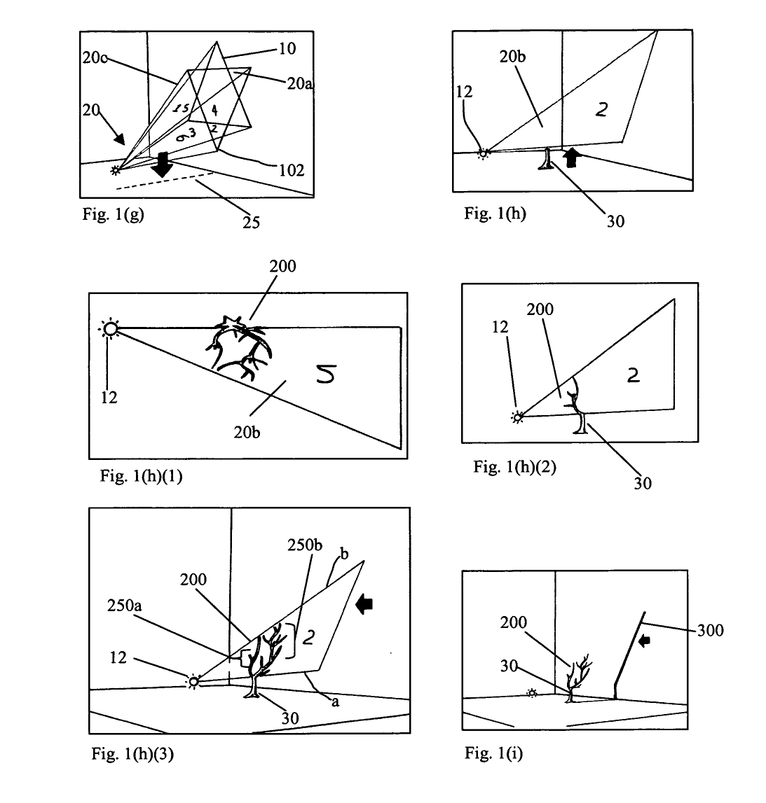

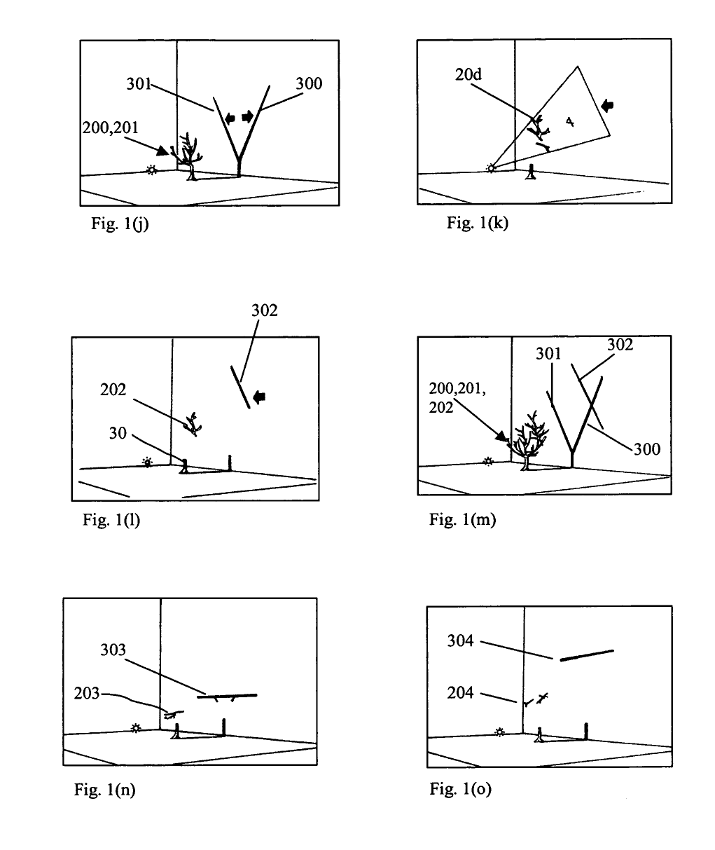

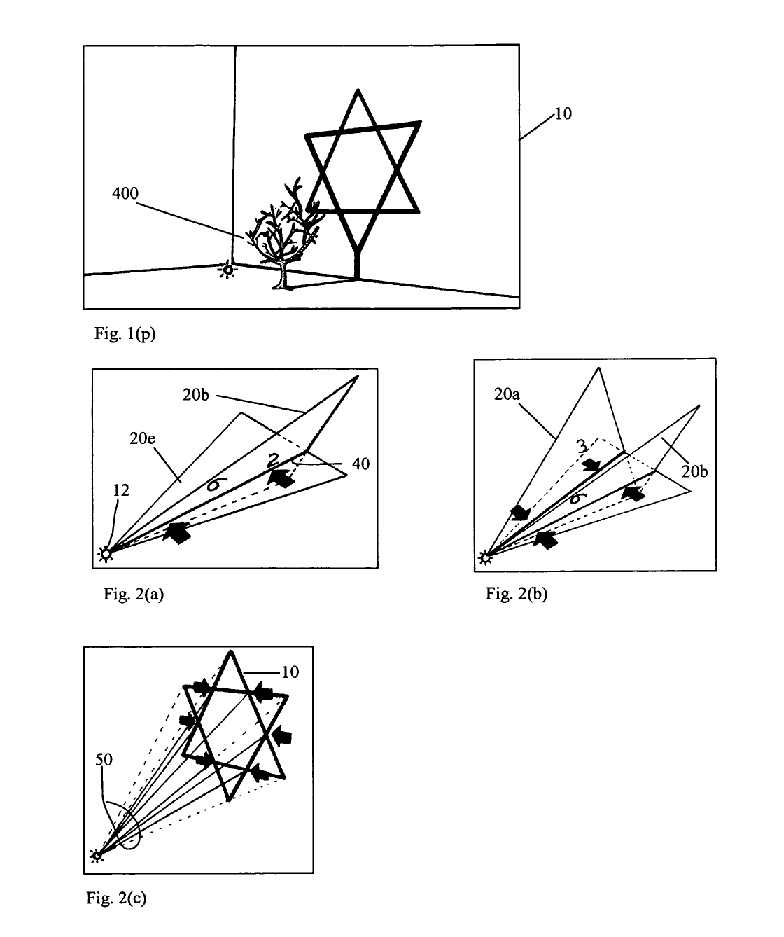

The apparatus and methodology for generating shadow displays according to the present invention is now described with respect to FIGS. 1-4. Preferably, the method comprises steps for the designing a three-dimensional object/structure such as a tree or bush having branches utilizing a state of the art Computer Aided Design (CAD) program such as Rhinoceros 3.0 or like computer-aided design software. Rhinoceros 3.0 (available through http://www.rhino3d.com) is a software tool that simulates a virtual building space and comprises a kit of tools that allows a user to create, simulate and render objects in a workshop setting provided via a computer display interface 99 (shown in the FIG. 1(a)). This software enables the build of three-dimensional objects that can be setup in an environment with determinate conditions and visualize its performance prior to having the objects physically built. Using this software, a tree/bush structure may be designed such that an observer would not be able to tell what the projected shadow would be from the shape of the structure.

By way of example, the apparatus and methodology for generating shadow displays is described for the case of designing a tree/bush structure that will result in the shadow display comprising a Star of David symbol. It is understood however, that a tree/bush structure may be constructed to create shadow displays comprising other religious symbols, e.g., a cross, a crescent moon, etc., or shadow displays comprising secular symbols, e.g., an object, animal, letters of the alphabet, numbers, a company logo, etc., or any object or visual concept having straight and/or curved edges.

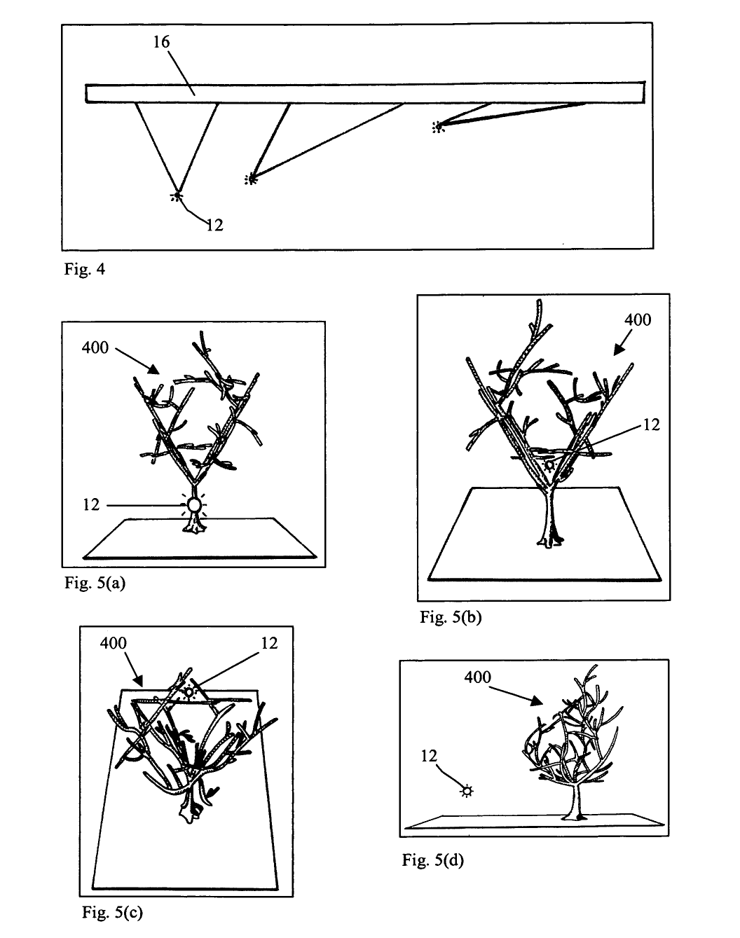

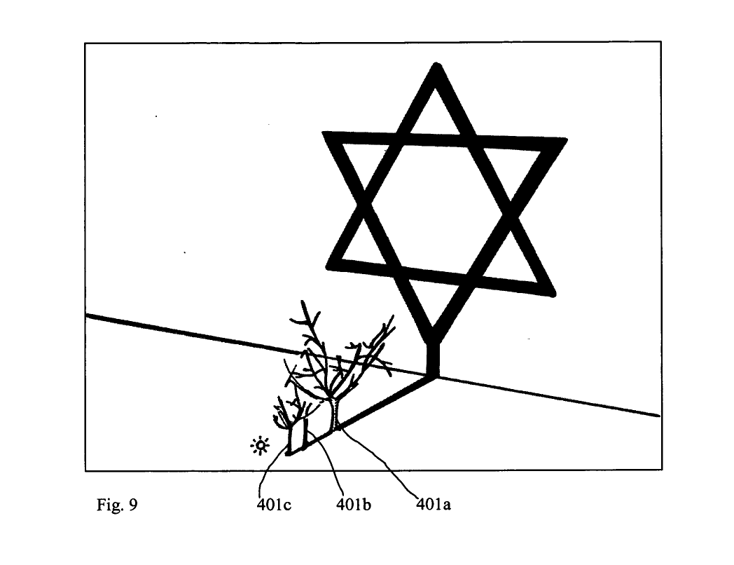

In a first step, utilizing the CAD software described herein, the shape/figure that is to be projected as a shadow on a back surface/wall defined via the software design tool. In the example shown in FIG. 1(a), the to be projected shadow is a “Star of David” symbol 10. While the defined shadow is described herein with respect to a known symbol (i.e., a Star of David), it is understood that the defined shadow may comprise any shape or symbol having straight or curved edges. A further method step is the definition of the location for a source of light indicated as a point light source 12 as shown in FIG. 1(b). In one embodiment, the light source may represent (and eventually comprise) a light bulb, however, it may include a candle, oil lamp, flash light, the sun, or like light source etc. It is understood as shown in FIG. 4, that the light source 12 may be located in any direction from the wall or surface. That is, the light source does not need to be perpendicular to the defined wall/surface 16 upon which the shadow is to be projected. It is understood that a surface to which the shadow image may be projected may include any flat surface, e.g., a wall, a building, a floor, or even the ground in the case of light source comprising the sun. In a next step, shown in FIGS. 1(c) and 1(d), lines 15, 16 are drawn from the limits 101 of the shape/figure to the fixed point representation 12 of the light source. After having drawn all the line connections between the defined projected shadow image 10 and the point light 12, in a next step, depicted in FIG. 1(e), perspective guide planes 20 or pads that will be used later to locate the branch members of the tree or bush structure are defined. FIG. 1(e) depicts a first guide plane 20a. For the defined shadow projection of the Star of David 10 shown in FIG. 1(f), there will be six (6) planes defined as there are six (6) limits 101 of the image. FIG. 1(f) depicts via in the CAD program user interface the definition of all planes 20 or pads together. In a further step, which may be optional, a position of the trunk/base for the resultant tree/bush is defined. It should be understood that there may be more than one tree/bush structures (e.g., two, three, or more) that may be used to produce a single projected shadow, and therefore, several base positions defined from which a tree/bush may be designed. For example, as shown in FIG. 9, a shadow display apparatus comprising three (3) tree/bush structures 401a, 401b, 401c in alignment have been designed to project a single Star of David shadow image 10. As shown in FIG. 1(g), a single base position 25 is defined. Implementing the CAD design software (e.g., Rhinoceros 3.0 or like equivalent) and via the interface 99, the user may then build a virtual trunk/base 30 out of the area in between the planes. The lowest limit of the planes 20 that have been defined is used as a reference. For example, as shown in FIG. 1(g), this lower limit is the plane defined by the projected image limit 102 of image 10. Then, as shown in FIG. 1(h), one of the planes defined by this lower limit, e.g., plane 20b is chosen and the user, via the CAD software interface, may build the virtual tree/bush segment 200 including branch members that lie totally parallel and flush to this plane in order to project a defined line shadow. As shown in the Figure, the branches may emanate in a plurality of directions as long as they are flush and lie inside the defined guide plane. FIGS. 1(h)(1) and 1(h)(2) illustrate respective top and side views of a branch member 200 created along a defined plane 20b. FIG. 1(h)(3) illustrates a perspective view of the branch member 200 created along the defined plane as shown in FIG. 1(h)(1). As shown in FIG. 1(h)(3), any virtual tree/bush segment including branches 250a, 250b that are specified by the user must lie in the defined plane such that they extend completely from the one edge of the defined plane, e.g., bottom edge “a” as depicted, to anywhere on the opposite edge, e.g., top edge “b” of the defined plane as depicted, such that a light directed onto that branch from the light source 12 will-result in the defined edge of the resultant projected shadow. This rule must be adhered for all branches specified on each of the defined planes, including horizontal or traverse lying planes defined. As depicted in FIG. 1(i), the virtual tree/bush segment 200 including branch members that lie totally parallel and flush to this defined plane will create a shadow segment 300 against the defined surface. The described method steps are repeated for each of the planes 20 shown in FIG. 1(f). For example, utilizing the defined plane labeled 20c, the user, via the CAD software design interface 99, may build a virtual tree/bush segment including branch members that lie totally parallel and flush to this plane in any conceivable direction along the plane that will project a defined line shadow. FIG. 1(j) depicts an Illustration of a composite virtual tree/bush segment including designed branch members 200, 201 and resultant shadows projected by these joined segments from the point light source created by the user via the CAD interface via the defined planes 20b, 20c, respectively. Continuing, for the case of a plane such as defined plane 20d that lies above the defined virtual tree/bush base structure 30 in a suspended position, it becomes necessary to join the branches at intersecting points. FIG. 1(k) illustrates a perspective view of a fourth virtual tree/bush segment including branch members 202 created along the defined plane 20d and shown suspended above the virtual base 30. FIG. 1(l) depicts the projected shadow 302 against the defined surface for this virtual tree/bush segment including branch members 202 defined along plane 20d. FIG. 1(m) depicts an Illustration of a composite virtual tree/bush segment including designed branch members 200, 201, 202 and resultant shadows projected by these joined segments from the point light source created by the user via the CAD interface via the defined planes 20b, 20c, 20d, respectively.

Consideration is now given to a traverse lying planes, such as defined plane 20e (FIG. 1(f)) and plane 20a (FIG. 1(e)) where the user may create virtual tree/bush segments including branch members 203, 204 along these defined planes that will result in the shadow lines 303, 304 such as depicted in FIGS. 1(n) and 1(o), respectively. When all of the virtual tree/bush segments including branch members 200, 201, 202, . . . and the base 30 have been created and joined, a tree/bush structure including branch members 400 depicted in FIG. 1(p) results with a resulting shadow display of the Star of David image 10 depicted. It is understood that via the CAD software, the resulting virtual tree/bush structure is represented as a virtual object, i.e., it is an object that exists as a file in the user's computer. While it may be manipulated, rendered with colors and texture, at this point, it only exists in a computer device.

As mentioned hereinabove, special consideration is given to the methodology for joining the branches that have been created via the CAD interface. Not only must the branches that have been created (e.g., branches 200-206) be joined, they must be kept tight to the projected shadow. In order to join the branches and keep it tight to the projected shadow, the joins in the intersection area, depicted as a guide line 40 between the planes must be located. The joins may be located in any point over the line 40 and in any amount. That is, if the user projects these lines from the point light source 12 to the wall/surface, the user will visualize the points where the virtual tree/bush segments including branch members that create the shadow are intersected. This intersection line (e.g. line 40) is the only place that the joins may be located because this line projects the point were the lines in the shadow change direction. It is understood that as many joins as desired may be located because they will always project one point because from the point of view of the light source, they are one behind the other. The illustration shown in FIGS. 2(a)-2(c) depicts up to six (6) arrows showing the intersections for the Star of David image 10. Thus, no matter how many points are located on the line 40, which is used as a guide, they are always going to project one point on the resultant shadow. FIGS. 2(a) and 2(b) illustrate the intersection of planes 20a and 20b respectively with traverse lying plane 20e. The line 40 indicates the intersection area in between the planes 20a, 20b and 20e. FIG. 2(c) depicts all defined planes of the resultant shadow (Star of David) and the intersection between all planes shown as guide lines 50. In FIG. 2(c), the arrows depict the intersection points in the shadow. The projection of the guide lines 50 will always end in an intersection point in the resultant shadow. Thus, during the design, the intersection of the planes must always be used to join the virtual tree/bush segments including branch members because in these intersections, the user may be further provided with the opportunity to change the direction of the branch and still keep in tight with the defined shadow.

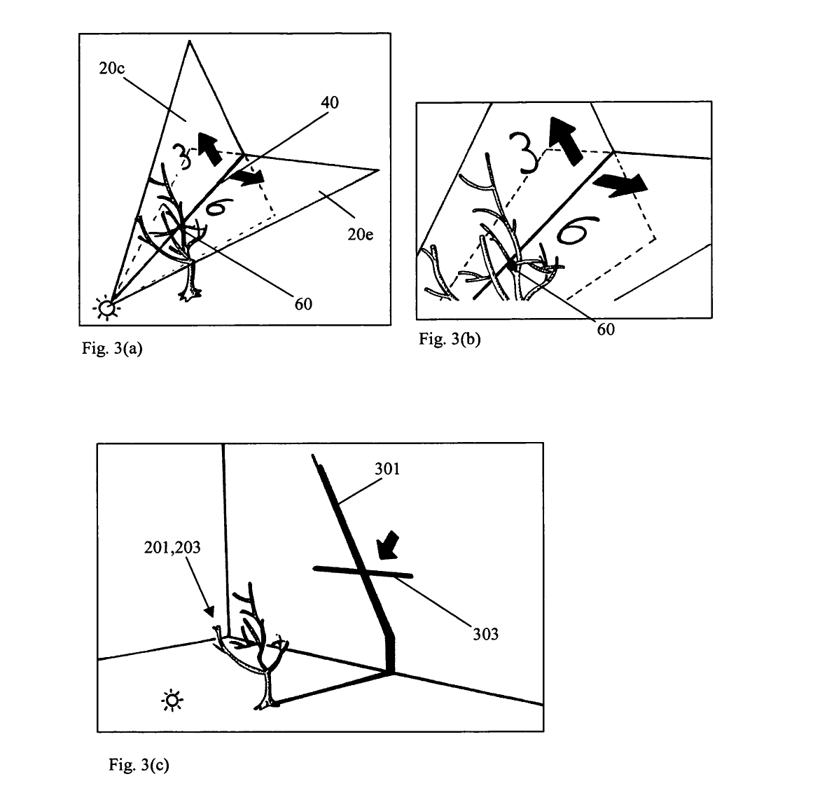

FIG. 3(a) illustrates an example of the join 40 in between the virtual tree/bush segments including branch members of the defined planes 20c and 20e. Both virtual tree/bush segments including branch members may be created to grow in different angles and direction but they have a common point that is shown at a location 60. This location or intersecting point 60 is located in the intersection of both planes as shown in the detailed view of FIG. 3(b). That is, the intersecting points 60 represent the possible places to locate the union between the virtual tree/bush segments including branch members. FIG. 3(c) illustrates the shadow projected by the virtual tree/bush segments including branch members 201 and 203 and the arrow indicates their intersection on the resultant shadow. By repeating the steps depicted in FIGS. 2 and 3, via the CAD interface, all of the virtual tree/bush segments including branch members may be joined.

Via the CAD software, as mentioned hereinabove, the resulting virtual joined tree/bush segments including branch members structure is represented as a three-dimensional virtual object that exists as a file in the user's computer. As known, the computer data files such as *.STL files or *.3dm files will include all solid coordinates, in three-dimensional space, and including the scale, positioning and intersection (join) points for all virtual tree/bush segments including branch members structure relative to each other and the point light source. While it may be manipulated, rendered with colors and texture, it only exists in a computer device. After the creation of the object, however, a real 3-d object may be created by first modeling it with a Stereography machine which is a well-known technology and often referred to as a three dimensional printing system that is adapted for building physical models directly from the CAD data. As known, a Stereography machine has a chamber full with nylon powder and it also has a glue goon that deposits the glue by layers to build a 3D model from the computer files. The resulting three-dimensional tree or bush structure eventually formed according to the methodology of the invention may comprise one or more materials including, but not limited to: plastic, ceramic, metal, paper, cardboard, wood, etc.

It is understood that according to the method of the invention, a variety of useful aesthetic and artistic objects may be created that would result in the generation of a shadow of a desired symbol or image. For example, the CAD software may be used to create objects that may be scaled up to become very large structures that may generate a shadow upon a desired surface when the position of the sun is at a certain position in the sky. Alternatively, the CAD software may be used to create objects that may be scaled down to reside on a platform that may serve as a candle or bulb holder when a candle or bulb light source is positioned thereon. Such an application would be found in the home, for example. While the defined shadow depicted in FIG. 1(p) of the present invention is a Star of David, it is understood that a resultant shadow may be another symbol such as a cross. Alternately, the symbol of a crescent moon and a star may be the resultant shadow. In the case of such a symbol having more than one (1) item, it would be necessary to create more than one shadow. However, it is understood that more than one tree/bush may be created according to the methodology defined herein. For example, additional steps would require the definition of additional bases, defined via the CAD interface in alignment with the defined (fixed) position of the light source and other bases from which joined tree/bush segments including branch members may be created to emanate from.

FIGS. 5(a)-5(d) depict view of an example tree/bush structure including branch members 400 that may be created from the virtual 3D model from the computer files created during the CAD design process exemplified by the present invention. Particularly, the views depicted in FIG. 5(a)-5(d) represent the model of a designed tree/bush with branch members structure relative to the light source 12 when viewed by an observer at different angles. As clearly seen, an observer at different angles will find it greatly difficult to identify the resultant shadow display image that would be projected.

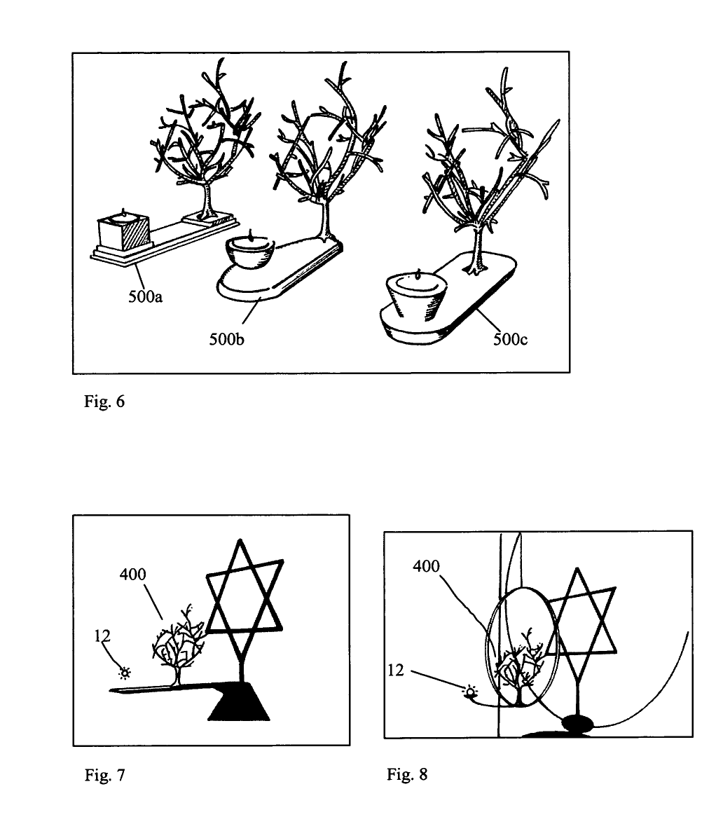

Thus, the present invention is contemplated for use as a shadow display apparatus and may be located on a platform or base as a candleholder, or may be mountable on a wall or suspended from a ceiling. It may additionally be part of a lamp device or even a clock. In one instance, the shadow display apparatus comprising tree/bush structure 400 may be scaled larger to be located in an outside location such that when the sunlight is directed to the object at a certain time of day, a shadow image may be displayed upon a surface, e.g., ground, at that certain time. As shown in FIGS. 6(a)-6(c), a base structure 500a-500b, 500c is provided that may be designed to house or support the light source, e.g., a candle or a miniature light bulb, and support the 3D object in a fixed position relative to the light source as designed. It is understood that the base for the tree/bush structure 400 and the source of light could be manufactured to be mountable on a base or platform that would lie on a table or flat surface as depicted in FIGS. 6(a)-6(c), or, may be wall mounted or ceiling suspended as shown in FIGS. 7 and 8 respectively.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

Having thus described our invention, what we claim as new, and desire to secure by Letters Patent is:

1. A shadow display apparatus comprising:
a light source for generating light;
a three-dimensional structure positioned a fixed distance from said light source and comprising a form representing a first image when viewed by an observer at a location other than at a position of said light source, said structure having embedded therein a three dimensional form of a second image separate and distinct from said first image, said object adapted to generate a shadow of said second image upon a surface when light from said light source is directed to said structure.

2. The shadow display apparatus as claimed in claim 1, wherein said first image comprises a form representing a tree or bush including a base portion and a plurality of branch members emanating therefrom in three dimensions.

3. The shadow display apparatus as claimed in claim 1, wherein said second image is a symbol selected from the group comprising: a “Star of David”, a crescent moon, a cross.

4. The shadow display apparatus as claimed in claim 1, wherein said second image is a symbol selected from the group comprising: letters of the alphabet or numbers.

5. The shadow display apparatus as claimed in claim 1, wherein branch members emanating from said base portion in each of said three dimensions are further adapted to emanate in a plurality of directions within each dimension.

6. The shadow display apparatus as claimed in claim 1, further including a means for fixing the position of said light source and said three-dimensional structure relative to the light source.

7. The shadow display apparatus as claimed in claim 1, wherein said fixing means includes a platform upon which said light source and said three-dimensional structure are supported.

8. The shadow display apparatus as claimed in claim 1, wherein said platform is adapted to be mounted on a surface upon which said shadow is generated.

9. The shadow display apparatus as claimed in claim 1, wherein said platform is adapted to be suspended from a ceiling or fixed structure.

10. The shadow display apparatus as claimed in claim 1, wherein said three-dimensional structure comprises one or more materials selected from the group comprising: plastic, ceramic, metal, paper, cardboard, wood, or combinations thereof.

11. The shadow display apparatus as claimed in claim 1, wherein said light source comprises an item selected from the group comprising: a light bulb, a candle, an oil lamp, a flash light.

12. A display apparatus for generating a shadow in the form of a Star of David comprising:
a light source for generating light;
a three-dimensional structure positioned a fixed distance from said light source and comprising a form representing a tree or bush when viewed by an observer at a location other than at a position of said light source, said tree or bush form including a base and a plurality of branch members emanating therefrom in three dimensions, said structure having embedded therein a three dimensional form of a Star of David such that said structure is adapted to generate a shadow of said Star of David upon a surface when light from said light source is directed to said structure.

13. The shadow display apparatus as claimed in claim 12, wherein branch members emanating from said base portion in each of said three dimensions, are further adapted to emanate in a plurality of directions within each dimension.

14. The shadow display apparatus as claimed in claim 12, further including a means for fixing the position of said light source and said three-dimensional structure relative to the light source.

15. The shadow display apparatus as claimed in claim 12, wherein said fixing means includes a platform upon which said light source and said three-dimensional structure are supported.

16. The shadow display apparatus as claimed in claim 12, wherein said platform is adapted to be mounted on a surface upon which said shadow is generated.

17. The shadow display apparatus as claimed in claim 12, wherein said platform is adapted to be suspended from a ceiling or fixed structure.

18. The shadow display apparatus as claimed in claim 12, wherein said three-dimensional structure comprises one or more materials selected from the group comprising: plastic, ceramic, metal, paper, cardboard, wood, or combinations thereof.

19. The shadow display apparatus as claimed in claim 12, wherein said light source comprises an item selected from the group comprising: a light bulb, a candle, an oil lamp, a flash light.

20. The shadow display apparatus as claimed in claim 12, wherein said light source includes the sun.

21. An apparatus for designing a three-dimensional (3-d) object capable of projecting a shadow display of a first image having one or more edges when said 3-d object is directed with light from a light source, said apparatus comprising:
a computing device having a display interface;
means for generating a representation of said shadow display image having edges on said display interface;
means for fixing a point light reference relative to said generated shadow display image and representing a scaled position of an eventual light source via said display interface;
means for defining via said display interface at least one perspective plane image having an edge corresponding to an edge of said generated shadow display image and terminating at said fixed point light reference; and,
means for specifying on each defined perspective plane image one or more virtual branch member structures lying along said perspective plane image emanating in a variety of directions in said plane wherein one or more of said branch members extends from one edge to an opposite edge of the perspective plane, said specifying being performed for each defined plane via said display interface;
means for enabling specification of one or more joins where one or more said virtual branch member structures lying along defined perspective plane images are intersected;
means for storing data representing said specified virtual branch member structures and joins; and,
and means for receiving said data representing said specified virtual branch member structures and joins, and creating said 3-d object from said received data, wherein said 3-d object is in a form representing a second image when viewed by an observer at a location other than at a position of said light source.

22. The apparatus as claimed in claim 21, wherein said second image comprises a form representing a tree or bush including a base portion and a plurality of branch members emanating therefrom in three dimensions.

23. The apparatus as claimed in claim 21, wherein said first shadow display image is a “Star of David”.

24. The apparatus as claimed in claim 21, wherein said means for specifying on each defined perspective plane image one or more virtual branch member structures lying along said formed plane image includes means for generating data representing position, coordinates and scale of said member branch member structures relative to said point light source.

25. The apparatus as claimed in claim 21, wherein said means for enabling specification of one or more joins includes means for generating data representing intersecting coordinates of one or more virtual branch member structures.

26. A method for designing a three-dimensional (3-d) object capable of projecting a shadow display of a first image having one or more edges when said 3-d object is directed with light from a light source, said method comprising steps of:
a) providing a representation of said shadow display image having one or more edges on a surface;
b) fixing a reference point relative to said generated shadow display image, said reference point representing a position of an eventual light source via said display interface;
c) defining a perspective plane having an edge corresponding to an edge of said shadow display image representation and terminating at said fixed reference point; and,
d) specifying on a defined perspective plane one or more branch-like member structures to lie along said perspective plane and specified to emanate in one or more directions in said plane, wherein one or more of said branch-like member structures extends from one edge to an opposite edge of the perspective plane;
e) specifying a join where one or more said specified branch-like member structures lying along one or more defined perspective planes are intersected; and
f) repeating steps c)-e) for all edges of said first shadow display image to produce a 3-D object having a form representing a second image when viewed by an observer at a location other than at said fixed reference point.

27. The method as claimed in claim 26, wherein said second image is a tree- or bush structure having a base portion and a plurality of branch-like members emanating therefrom in three dimensions.

28. The method as claimed in claim 26, wherein said first shadow display image is a “Star of David”.

29. A method for designing a three-dimensional (3-d) object capable of projecting a shadow display of a first image having one or more edges when said 3-d object is directed with light from a light source, said method comprising steps of:
a) providing a computing device having a display interface;
b) generating a representation of said shadow display image having edges on a virtual surface formed in said display interface;
c) fixing a reference point relative to said generated shadow display image, said reference point representing a position of an eventual light source via said display interface;
d) defining via said display interface a virtual perspective plane image having an edge corresponding to an edge of said generated shadow display image and terminating at said fixed reference point; and,
e) specifying, via said display interface, on said defined perspective plane image, one or more virtual branch-like member structures to lie along said perspective plane and specified to emanate in one or more directions in said plane, wherein one or more of said branch-like member structures extends from one edge to an opposite edge of the perspective plane;
f) specifying via said display interface a join where one or more said specified virtual branch-like member structures lying along one or more defined perspective plane images are intersected;
g) repeating steps d)-f) for all edges of said first shadow display image until a virtual 3-d object is generated;
h) storing data representing said specified virtual branch member structures and joins in said computing device; and,
i) receiving said data representing said specified virtual branch-like member structures and joins, and creating said 3-d object from said received data, wherein said 3-d object is in a form representing a second image when viewed by an observer at a location other than at a position of said light source.

30. The method as claimed in claim 29, wherein said second image comprises a form representing a tree or bush including a base portion and a plurality of branch members emanating therefrom in three dimensions.

31. The method as claimed in claim 29, wherein said first shadow display image is a “Star of David”.

32. The method as claimed in claim 29, wherein said step of specifying on each defined perspective plane image one or more virtual branch member structures includes the step of generating data representing position, coordinates and scale of said specified member branch member structures relative to said point light source.

33. The method as claimed in claim 29, wherein said step of specifying of one or more joins includes the step of generating data representing intersecting coordinates of one or more virtual branch member structures.
